(19) United States
(12) Patent Application Publication
(10) Pub. No.: US 2015/0358270 A1
(43) Pub. Date: Dec. 10, 2015

(54) System and method for targeting information based on a list of message content

(71) Applicants: Jared Jacobs, Palo Alto, CA (US); Niniane Xin Wang, Mountain View, CA (US)

(72) Inventors: Jared Jacobs, Palo Alto, CA (US); Niniane Xin Wang, Mountain View, CA (US)

(21) Appl. No.: 11/128,566

(22) Filed: May 12, 2005

(51) Int. Cl. H04L 12/58; G06F 3/0484; G06F 3/0482

(52) U.S. Cl. CPC H04L 51/16; G06F 3/0482; G06F 3/04842

(57) ABSTRACT

Targeted information is provided in accordance with one or more conversations from a list of conversations. At least one portion of a conversation from each of conversation in a list of conversation can be selected. From the selected portions, at least one conversation can be chosen. The conversation can be chosen based on a number of criteria such as a number of distinct keywords or word phrases present in the selected portion from a list of keywords or word phrases. One or more content components from the chosen conversation can be used to obtain targeted information, such as an advertisement. Targeted information can also be obtained by scanning a conversation description and a snippet for each conversation in a list of conversations to identify keywords or word phrases. Targeted information can be obtained using the identified keywords or word phrases.

### RELATED APPLICATIONS

This application is related to U.S. patent application Ser. No. 10/914,035, filed Aug. 6, 2004, entitled “Displaying Conversations in a Conversation-Based Email System” which application is incorporated by reference herein in its entirety. This application is also related to U.S. Patent Application No. _____, filed Apr. 20, 2005, entitled “System and Method for Targeting Information Based on Message Content” which application is incorporated by reference herein in its entirety.

### TECHNICAL FIELD

The disclosed embodiments relate generally to providing information to computer users.

### BACKGROUND

As with traditional advertising, online advertising seeks to provide advertising to individuals likely to respond to the advertisement in some way, for example, by increasing a user's awareness of the brand or by ultimately stimulating a user to purchase a product or service. One way advertisers target a user is to provide advertisements that are related to the content of a web page that the user is viewing. Some advertising systems are designed to receive an input of content and return advertisements based on that content.

### SUMMARY

According to some embodiments, a method of presenting information includes identifying a set of content components, where each content component comprises at least a subset of a respective source content. A determination is made as to whether one or more in the set satisfies a condition. Content is identified in accordance with the determination and information is obtained relevant to the identified content.

### BRIEF DESCRIPTION OF THE DRAWINGS

For a better understanding of the nature and embodiments of the invention, reference should be made to the Description of Embodiments below, in conjunction with the following drawings in which like reference numerals refer to corresponding parts throughout the figures.

FIG. 1 is a block diagram of an exemplary system that generates targeted information based on message content in accordance with some embodiments of the present invention.

FIG. 2 is a flow diagram of a process for generating targeted information based on a message list in accordance with some embodiments of the invention.

FIGS. 3A and 3B illustrate exemplary screenshots of a conversation list and targeted information in accordance with some embodiments of the presentation.

FIG. 4 is a block diagram of an exemplary client in accordance with some embodiments of the invention.

FIG. 5 is a block diagram of an exemplary information service in accordance with some embodiments of the invention.

### DESCRIPTION OF EMBODIMENTS

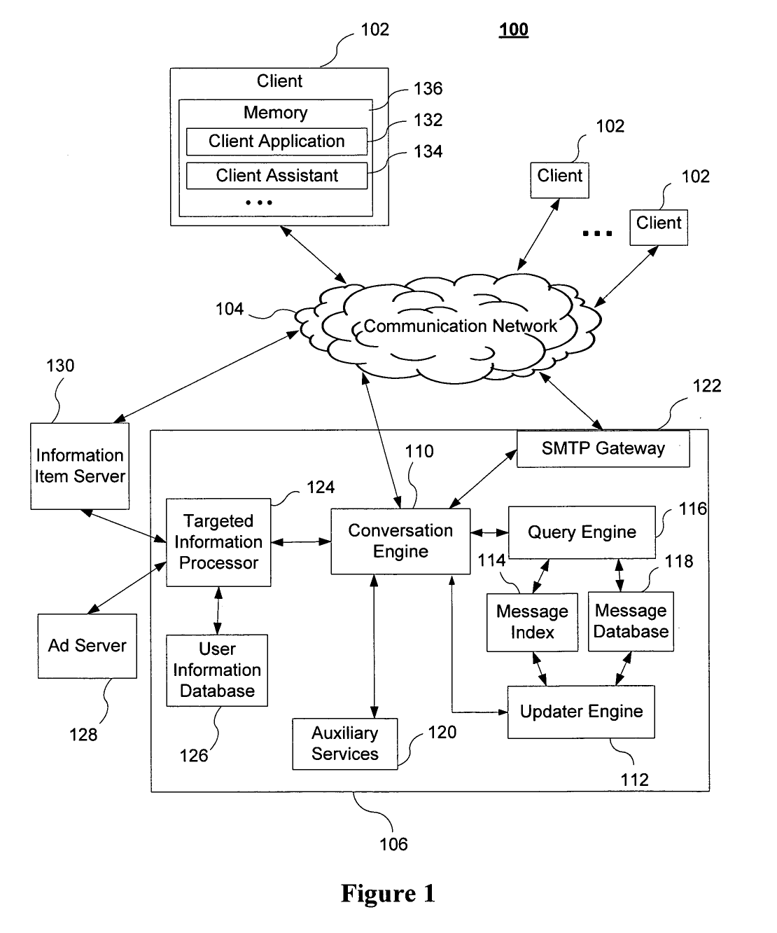

FIG. 1 is a block diagram of a system 100 for implementing some embodiments of the invention. One or more clients 102 can be connected to a communication network 104. The communication network 104 can be connected to an information service 106. The information service 106 can include a conversation engine 110, an updater engine 112, a message index 114, a query engine 116, a message database 118, one or more auxiliary services servers 120, an SMTP gateway 122, a targeted information processor 124, and a user information database 126. The targeted information processor 124 can be connected to an ad server 128 and/or an information item server 130.

The client 102 can be any of a number of devices (e.g., a computer, an internet kiosk, a personal digital assistant, a cell phone, a gaming device, a desktop computer, or a laptop computer) and can include a client application 132, a client assistant 134, and other applications or data stored in client memory 136. The client application 132 can be a software application that permits a user to interact with the client 102 and/or network resources to perform one or more tasks. For example, the client application 132 can be a browser (e.g., Firefox) or other type of application that permits a user to search for, browse, and/or use resources (e.g., web pages and web services) on the client 102 and/or accessible via the communication network 104. The client assistant 134 can perform one or more tasks related to monitoring a user's activities with respect to the client application 132 and/or other applications, searching or browsing for resources (e.g., files) on the client 102, and processing information received from or being sent to information service 106. The client assistant 134 can be part of the client application 132, for instance a plug-in to the client application 132 (provided, for example, from various online sources), or provided as a stand-alone program. The client assistant 134 can be a web-based messaging application such as the client executable portion of the Google Gmail product. In particular, the client assistant 134 may be embedded in one or more web pages downloaded to the client 102 from a remote server. The client assistant 134 can include JavaScript instructions embedded in the one or more web pages, and those JavaScript instructions can be executed by the client 102 in an environment (e.g., a virtual machine environment or program interpreter) provided by the client application 132. Client memory 136 can store system information and information about a user, among other things.

The communication network 104 can be any local area network (LAN) and/or wide area network (WAN), such as an intranet, an extranet, or the Internet. It is sufficient that the communication network 104 provide communication capability between the clients 102 and the information service 106. In some embodiments, the communication network 104 uses the HyperText Transport Protocol (HTTP) to transport information using the Transmission Control Protocol/Internet Protocol (TCP/IP). HTTP permits client computers to access various resources available via the communication network 104. The various embodiments of the invention, however, are not limited to the use of any particular protocol. The term “resource” as used throughout this specification refers to any piece of information or service that is accessible via a Uniform Resource Locator (URL) and can be, for example, a web page, a document, a database, an image, or a computational object.

The conversation engine 110 can respond to a variety of requests from the client assistant 134 related to messages and return conversation-based responses via its connection with the communication network 104. A conversation can include one or more relevant messages relating to a conversation topic. Various criteria can be used to determine which messages are part of each distinct conversation. For example, an analysis can be made of the contents of a user's message and messages whose contents are found to be related can be grouped together. In another example, a thread identifier found in a message header can be used to identify related messages. In yet another example, a subject line in the message header can be used to identify related messages. The senders and recipients of the messages are considered participants in the conversation. All messages directed to a user of the information service 106 can be grouped into a plurality of conversations and presented to the user in a conversation-based format, individually or jointly. In a conversation list view, a user can see a listing of the user's conversations in summary form. In a conversation view, the user can see one or more of the conversation messages in an expanded form.

The information service 106 can create a snippet of a conversation and/or a message. A snippet provides a user with a preview of the contents of the conversation or message without the user having to open the conversation or the message. In a list of conversations, a snippet can be generated from the most recent message in the conversation. A snippet can also be extracted from the first message (e.g., an oldest message) in the conversation. A snippet can also be extracted from all the messages in the conversation according to predefined heuristic rules, e.g., listing a set of keywords appearing most frequently in the conversation. If the information service 106 is preparing a list of conversations in response to a search submitted by a user, the information service 106 can create a snippet including a highlighted portion that matches user-submitted query terms, which may be similar in one or more respects to snippets included in search results returned by a search engine, such as the Google search engine. In a conversation view, a snippet can be generated for one or more messages in the conversation. Snippets can be generated based on a user profile. A user profile can contain information about a user such as the user's preferences with respect to certain types or categories of information and/or terms. One or more user profiles can be stored in the user information database 126. Alternatively, or in addition to, a user profile can be stored in a cookie stored on a user's computer. The user profile can be provided to the information service 106 as part of a search request. User profiles can be created in a variety of ways, such as by receiving information from a user, and/or by inferring information about a user from the user's computing activities such as browsing, searching, messaging, and use of various software applications (e.g., a word processing application).

The SMTP gateway 122 is also connected to the communication network 104. The SMTP gateway 122 can be directly involved in receiving and sending messages. In some embodiments, the SMTP gateway 122, for example, transmits and receives messages using the simple mail transfer protocol (SMTP). The SMTP gateway 122 can receive a new message from the communication network 104 and send the message to conversation engine 110 for additional processing. Additionally, the SMTP gateway 122 can receive messages from the conversation engine 110 and then transmit (via the communication network 104) those messages to recipient addresses specified in the messages.

The one or more auxiliary services servers 120 can provide additional services to the conversation engine 110. The auxiliary services servers 120 can, for example, include a spam detection module for detecting and processing spam and/or an attachment management module for managing the storage and retrieval of files attached to messages.

As mentioned above, the conversation engine 110 can be connected to a targeted information processor 124. The targeted information processor 124 can provide information items for display to a user at the client 102. The targeted information processor 124 can provide, for example, advertisements and/or other information items related to content (e.g., messages or conversations) being provided to the client assistant 134. The targeted information processor 124 can be connected to the user information database 126 to use information about a user (e.g., a user profile) to affect the targeted information provided to the user.

FIG. 1 is exemplary. In some embodiments, the information service 106 contains a subset or superset of those elements illustrated in the figure. Although FIG. 1 shows the information service 106 as a number of discrete items, the figure is intended more as a functional description of the various features which may be present in the information service 106 rather than a structural schematic of the various embodiments. In practice, and as recognized by those of ordinary skill in the art, items shown separately could be combined and some items could be separated. Some items shown separately in the figure could be implemented by a single server and some single items could be implemented by one or more servers. For example, the message database 118 can be implemented using a plurality of servers. In another example, one or more of the capabilities of the targeted information processor 124 can be included in the conversation engine 110. The actual number of servers in the information service 106 and how features are allocated among the various servers will vary from one implementation to another, and may depend in part on the amount of traffic that the system must handle during peak usage periods as well as during average usage periods.

As mentioned above, the client 102 can include a client application 132 and a client assistant 134. The client application 132 can provide a window used for displaying. conversations. The conversations and messages in the conversations can be encoded using HyperText Markup Language (HTML), eXtensible Markup Language (XML), or any other appropriate markup language or encoding, and then rendered by the client application 132. When a user submits a request through the client application 132 to the information service 106 to access messages stored in the user's account, the information service 106 identifies conversations in the user's account in accordance with the user's request and transfers one or more portions of them as well as a set of display instructions back to the client 102. The client assistant 134 can, in response, generate one or more forms in accordance with the display instructions, where each form can include information of some of the conversations. The forms can then be submitted to and rendered by the application 132. In one embodiment, the client assistant 134 may alternatively exist and operate in the information service 106.

The information service 106 and the client assistant 134 can work together to allow a user to view and/or search messages in a user's message account and to present the search results in a highly intuitive fashion. The information service 106 can extract information from a user's message account (e.g., an e-mail account) or process a message being composed by the user, while the client assistant 134 can assist in rendering the information prepared by the information service 106. In other embodiments, a different division of duties between the information service 106 and the client assistant 134 can be used. Because many of the tasks can be performed by either the information service 106 or the client assistant 134 or by the two working together, these two components are sometimes referred to jointly in this specification as the “conversation system”.

The conversation system can provide at least two different views including a conversation list view and a conversation view, both as mentioned briefly above. In a conversation list view, a plurality of conversations can be displayed, where each conversation can be displayed in a summary form. For example, each conversation can be represented by a number of conversation elements. The conversation elements can include one or more of: a number indicating the number of messages in the conversation, a list of one or more of the identifiers or names of the senders of messages in the conversation, a conversation description (e.g., the text of a subject line of one of the messages in a conversation), a date/time value of the conversation (e.g., a date/time value of the last received message in the conversation), and a snippet from one or more of the messages in the conversation. In some embodiments, each conversation can be represented in a single row in a list of conversations.

In a conversation view, one or more messages from a conversation can be displayed. Each message can be displayed in one of a number of various modes, for example an expanded mode, a compacted mode, or a compressed mode. In an expanded mode, the body of the message can be displayed along with, for example, header information including the names or other identifiers of the sender and the recipients of the message, a date/time of the message, routing information, and other properties of the message. An expanded mode can be used, for example, for messages which are new. In a compacted mode, the body can be hidden and a snippet from the message provided in its place. The snippet can be chosen to occupy less space than the body. For example, snippets can be chosen to occupy one line in a display window. The compacted mode can be used for messages which have been read. The compacted mode can allow messages to be displayed in a window more densely than if the expanded mode were used. In a compressed mode, a message can be represented with a small bar. The small bar can contain no message information. The visual effect of such a mode can be that multiple compressed messages appear like the edges of cards in a deck of cards. A user can toggle between the various display modes by selecting a message or using various controls in the display window. It should be understood that the techniques described in this specification with reference to a conversation (as might be found in the Google Gmail product) can be equally used with any message system (e.g., Outlook or Thunderbird) where messages can be displayed in various views (and can include portions of messages) such as a message view or a thread view where related messages can be displayed.

When a list of conversations is being displayed, additional information (sometimes referred to in this specification as “information items”) can be displayed. For example, one or more advertisements relevant to, or related to, one or more of the conversations in the conversation list can be displayed. In another example, one or more other types of information can be displayed. Such other information can include, but is not limited to news items, map links, product reviews, phone numbers, web page links, dictionary entries, images, RSS feeds, blog (web log) events, user polls, links to files or other content on the client 102, and other types of information. In some embodiments, the relevant information displayed to the user can depend on information about the user stored in the user information database 126.

RSS feeds 114 can be content distributed from various sources on a network (e.g., the Internet). RDF Site Summary (RSS) (and sometimes, Real Simple Syndication) is an XML-based lightweight multipurpose extensible metadata description and syndication format. RSS is typically used for distributing various types of content to a number of receivers simultaneously. News items can be news items from one or more sources. Blog events can be events generated from one or more web logs (blogs). User polls can be polls that the user may participate in which may come from a variety of sources.

When a user is viewing a list of conversations and possibly associated snippets, it can be useful to display advertising or other information which may be of interest to the user. However, determining what information to display to the user can sometimes be difficult.

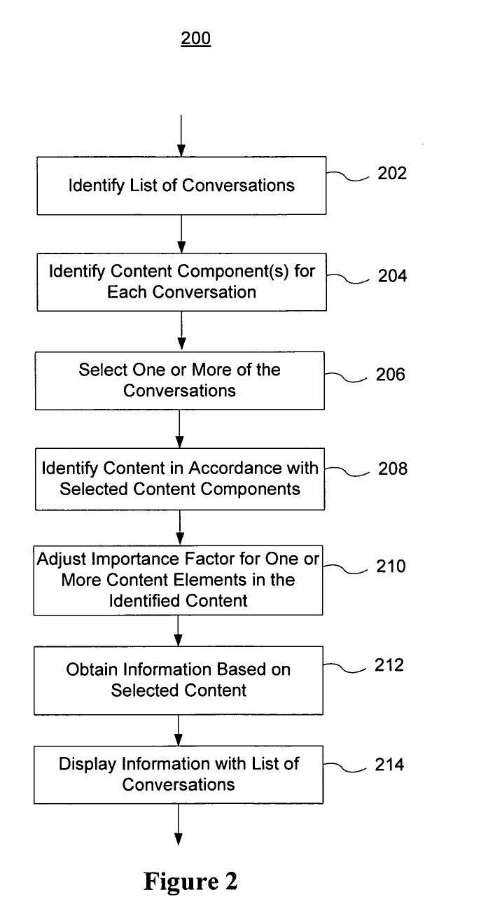

FIG. 2 illustrates a process by which information can be generated for a list of conversations and then displayed along with the list of conversations according to some embodiments of the invention. Initially, a list of conversations is identified (202). A list of conversations can be generated as a result of a number of different actions. For example, a search query can be applied against a database of messages. One or more relevant conversations can be returned in response to the search query. Generally speaking, a conversation is relevant to a search query when one or more parts of the conversation are relevant to the search query (e.g., the conversation contains one or more messages whose contents are relevant to the search query). The relevancy of a particular content to a search query can be determined by any number of well known techniques. Search queries can be explicit or implicit. An explicit search query can include accepting one or more search terms affirmatively entered by the user. An implicit search query can include searches based on a particular message view (e.g., an Inbox view), a label, or other information. Labels can be applied to conversations and/or messages. A user can choose to search for a particular label by selecting that label from a list of labels. Labels can be user created and/or system created. In some embodiments, a user's inbox can be thought of an implicit search for conversations and/or messages having an “inbox” label.

Once the list of conversations has been identified (202), content components for each conversation in the list can be identified (204). Content components can be identified for a subset of conversations in the list. For example, a subset can comprise those conversations which are in a current display window provided to the user. A content component can be any portion of a conversation. For example, the content components for a conversation can comprise a snippet of the conversation and/or the conversation description. The content components can also comprise one or more portions of one or more of the messages in the conversation and/or the conversation itself. One or more portions of a message can include header information or other information associated with a message or a conversation (e.g., a date/time value of when a message was viewed or the subject line of the message).

One or more conversations can then be selected (206) according to various criteria based on the identified content components. A single conversation can be selected by being a top most conversation in the list (e.g., a conversation having a most recently received message). A single conversation can be selected based on which conversation was most recently viewed. A single conversation can be selected by having a most recently received message which has been viewed. A single conversation can be selected by being a most recently viewed conversation for which at least one advertisement had been presented. A single conversation can be selected by being a most recently viewed conversation for which no advertisement has been presented, or for which the number of presented advertisements is equal to or less than the number of advertisements presented with other recently viewed conversations. A single conversation can be selected at random from those conversations which have already been viewed. It may be noted that the term “random”, when used in this document to refer to selecting or choosing one or more items from a set or list, encompasses both random and pseudorandom selection methodologies. For instance, “randomly” selecting a term from a set of terms (or a conversation from a set of conversations) may be accomplished by randomly or pseudo-randomly generating a value in a predefined range (e.g., between 0 and 1) and then using that value to select a term (or conversation) from the set.

A single conversation having a highest number of words and/or word phrases from a list of words and/or word phrases can be selected. In some embodiments, the number can be based on the number of distinct words and/or word phrases from the list which are present in the content components of the conversation. A list of words or word phrases can be created, for example, from keywords and/or word phrases associated with advertisements, where the advertisements have been frequently selected by a community of users over a period of time. Users can select an advertisement by, for example, clicking on the advertisement when the advertisement is presented to the user. Advertisements can be chosen for presentation to a user by being associated with a particular keyword or word phrase. Advertisers can bid on keywords and/or word phrases such that when the bid-upon keyword and/or word phrase is present in a content (e.g., in a search query or a web page), the advertisement from the advertiser having the highest bid for that keyword or word phrase can be presented. Of course, other factors can affect which advertisements are presented (e.g., advertisements can be selected, at least in part, in accordance with a user's profile, in accordance with a calculated score indicating how relevant the advertisements are to the content, and/or in accordance with the respective click-through rates of the advertisements). A list of keywords and/or word phrases used for selecting a conversation and/or conversations can be those keywords and/or word phrases having selection rates (e.g., advertisements being selected based on the keywords and/or word phrases) greater than a threshold. The list can be a number of keywords or word phrases (e.g., 1000) having the highest selection rates, for example. A single conversation can be selected from among conversations having a number of distinct keywords and/or word phrases from the list present in their identified content components greater than threshold. The conversation selected can be randomly selected from among those conversations.

In some embodiments, a conversation can be selected based on an advertising metric determined using the conversation's content components. The advertising metric can be determined based on various factors such as a predicted click-though metric which represents a predicted probability of a user selecting co-displayed advertising based on the content. The advertising metric can be based on a user's actual advertising selections in the past.

In some embodiments, more than one conversation can be selected. For example, those conversations having a number of distinct keywords and/or word phrases from the list present in their identified content components greater than threshold can be selected. In another example, the first N conversations (e.g., 5) in the conversation list can be selected where N is an integer from 0 to the number of conversations displayed to the user. In yet another example, the first U conversations having unread messages in the conversation list can be selected, where U is an integer up to the number of conversations displayed to the user. In still yet another example, all of the conversations in the list can be selected.

Once a conversation (or conversations) is selected at 206, content can be identified (208) that will be used to obtain relevant information at a later step. The identified content can include one or more of the elements of a conversation. A conversation's elements can include one or more of: a number indicating the number of messages in the conversation, a list of one or more sender identifiers or names of senders of messages in the conversation, a conversation description (e.g., the text of one of the messages in the conversations), a date/time value of the conversation (e.g., a date/time value of the last received message in the conversation), a snippet from one or more of the messages in the conversation, and one or more portions of one or more of the messages in the conversation. The one or more message portions can include header information or other information associated with a message (e.g., a date/time value of when a message was viewed). In one embodiment, the identified content can be the conversation description and the snippet of the selected conversation(s) displayed in a conversation list presented to the user. In another embodiment, one or more of the conversation elements from the identified conversation(s) can be examined to identify those keywords from a list of keywords and or word phrases (e.g., names of products, brands or businesses) that are present. The content identified at 206 can be one or more of the identified keywords and/or word phrases chosen at random.

It may be that no conversation is selected at 206. In this instance, one or more portions of any (or all) of the conversations can be used as the identified content. For example, the identified content can be all of the descriptions of the conversations along with their respective snippets. In another example, the identified content can be one or more portions of one of the conversations selected at random.

In some embodiments, the identified content from 208 can be modified by adjusting an importance factor associated with one or more content elements in the identified content. This can be useful because some information servers (e.g., ad server 128 or information server 130) can accept information relating to an importance of one or more portions of the input relative to the other portions. Accordingly, based on various criteria, it can be determined that one or more portions of the identified content from 208 to be provided as an input to an information server should be treated differently from other portions. Adding this importance factor information can cause the output of the information server to be weighted toward those portions deemed important and/or down-weighted for portions deemed unimportant. In some embodiments, one or more elements associated with a particular part of a pattern identified in a conversation can be accorded importance factors different from others parts of the pattern. For example, an element associated with a product name can be accorded more weight than other elements (e.g., the text of an indicated shipping method such as “air freight”). In another example, an element identified as a destination shipping address in a receipt for an online purchase can be down-weighted in importance.

In another example of modifying importance factors, the content identified at 208 can be examined to identify which keywords and/or word phrases from a list of keywords and/or word phrases are present in the content. From the keywords and/or word phrases identified in the content, one or more of these keywords and/or word phrases can be selected and their importance factors modified. The keywords and/or word phrases can be selected in any number of ways. For example, one or more of the keywords or word phrases can be selected at random from the identified keywords and/or word phrases present in the content. In another example, one or more of the keywords or word phrases having advertising metrics (e.g., a selection rate) greater than other keywords or word phrases can be selected. In yet another example, one or more of the keywords or word phrases having profile similarity scores greater than other keywords or word phrases can be selected. A profile similarity score for each keyword or word phrase can be determined by, for example, comparing the keyword or word phrase to the user's profile according to various criteria. The more closely aligned a keyword or word phrase is to the user's profile, the higher the profile similarity score will be. Those content elements corresponding to the selected keywords or word phrases can have their respective importance factor increased.

Furthermore, keywords and/or word phrases can be added to the content identified at 208. These keywords and/or word phrases can be related to the identified content, and can be known to result in information items (e.g., advertisements) with a higher selection rate. In some embodiments, the additional keywords and/or word phrases are selected from keywords and/or word phrases known to be correlated with words and/or word phrases in the identified content. For example, an abbreviation of a product name can be correlated with the full name of the product. Therefore, when the abbreviation is identified in the content, the full product name can be added to the content (and vice versa).

Once the content is identified at 208 and, if desired, certain importance factors modified at 210, the identified content can be used to obtain information relevant to it (212). In response to receiving the identified content, the targeted information processor 124, for example, can return information (hereinafter called the targeted information) to the conversation engine 110 relevant to the identified content. As mentioned above, the targeted information can include, but is not limited to, one or more of the following: advertisements, product reviews, news items, map links, phone numbers, web page links, dictionary entries, images, RSS feeds, blog (web log) events, user polls, and other types of information. The targeted information obtained for the user can depend on information about the user (e.g., a user profile) stored in the user information database 126. The information in the user profile can be used by the targeted information processor 124 to enhance a likelihood that the targeted information is consistent with the preferences indicated in the user profile.

The targeted information can be displayed along with the list of conversations (214). The conversation engine 110 can receive the information from the targeted information processor 124 and determine formatting information which can be used, for example, by a client application (e.g., client application 132) to display the list of conversations and the targeted information. The conversation engine can send the formatting information, the targeted information, and list of conversations to the client 102 in one or more transmissions.

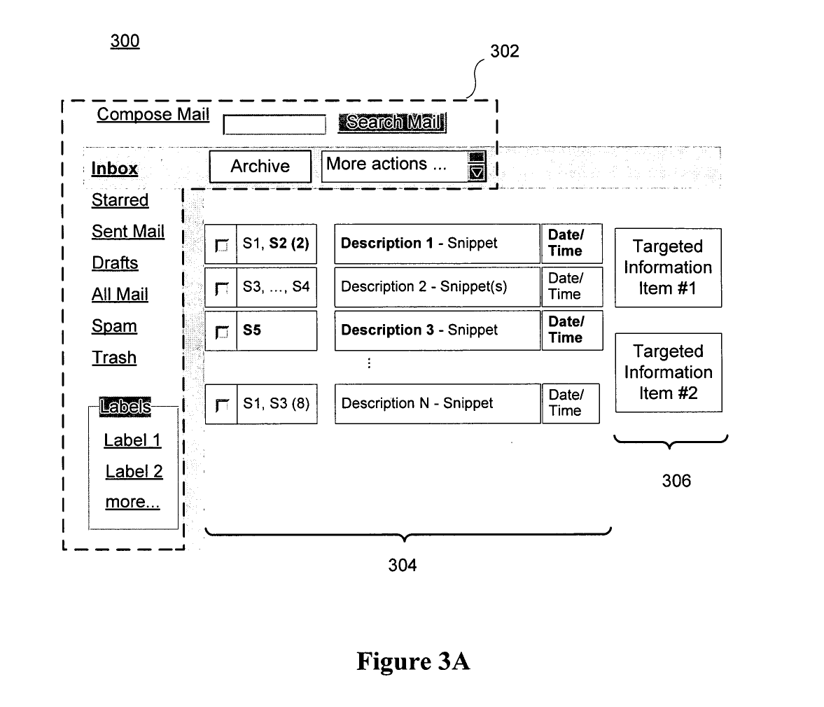

FIG. 3A provides an exemplary screenshot of a display with a conversation list and targeted information items in accordance with some embodiments of the invention. FIG. 3A provides one exemplary display organization for illustration purposes only and does not serve to limit the ways conversation lists and targeted information items can be displayed. The display area 300 can include three major display portions: a navigation and control portion 302, a message list portion 304, and a targeted information items portion 306. The navigation and control portion 302 can include one or more navigation and/or control items (e.g., “compose email”). The message list portion 304 can include one or more conversations in summary form. The summary form of a conversation can include a conversation description and a snippet from the conversation. The targeted information items portion 306 can include one or more information items which have been obtained as a result of the techniques described above. For example, the information items can be obtained from an ad server 128 and/or an information item server 130 (FIG. 1). Although FIG. 3A shows two information items, the number of information items may be smaller or larger, and may vary from one conversation list view to another. FIG. 3A illustrates only one exemplary layout configuration and other layouts are possible. For example, the relative positions of the display areas to each other can change (e.g., the targeted information 306 can be displayed to the left, right, bottom, or top relative to the conversation list portion 304). For example, FIG. 3B provides exemplary screenshot of a display with a conversation list and a targeted information item in accordance with some embodiments of the invention. A display area 308, like the display area 300, can include a navigation and control portion 302 and a message list portion 304. However, in FIG. 3B a targeted information items portion 310 can be positioned above the message list portion 304. Navigation buttons 312 can optionally be provided to navigate forward and backward through a list of targeted information items.

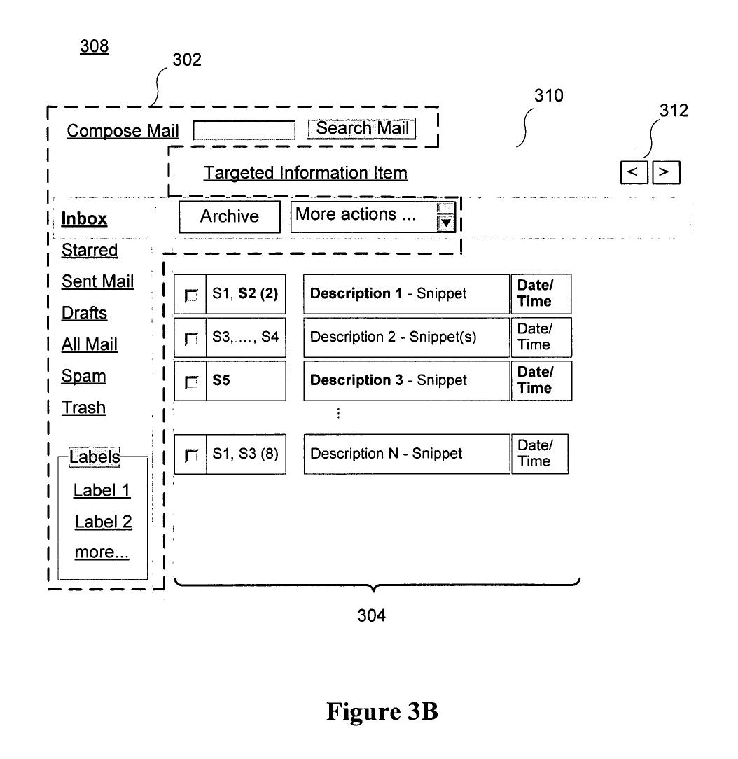

FIG. 4 is a block diagram illustrating a client 102 in accordance with one embodiment of the present invention. The client 102 typically includes one or more processing units (CPUs) 402, one or more network or other communications interfaces 404, memory 136, and one or more communication buses 408 for interconnecting these components. The client 102 optionally may include a user interface 410 comprising a display device 412 and a keyboard 414. Memory 136 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 136 may optionally include one or more storage devices remotely located from the CPU(s) 402. In some embodiments, memory 136 stores the following programs, modules and data structures, or a subset thereof:
an operating system 416 that includes procedures for handling various basic system services and for performing hardware dependent tasks;
a network communication module 418 that is used for connecting (wired or wireless) the client 102 to other computers via the one or more communication network interfaces 404 and one or more communication networks, such as the Internet, other wide area networks, local area networks, metropolitan area networks, and so on;
a client application 132 that can permit a user to interact with the client 102 as described above;
a client assistant 134 that can perform one or more tasks as described above; and
optionally, a user profile 420 as described above.

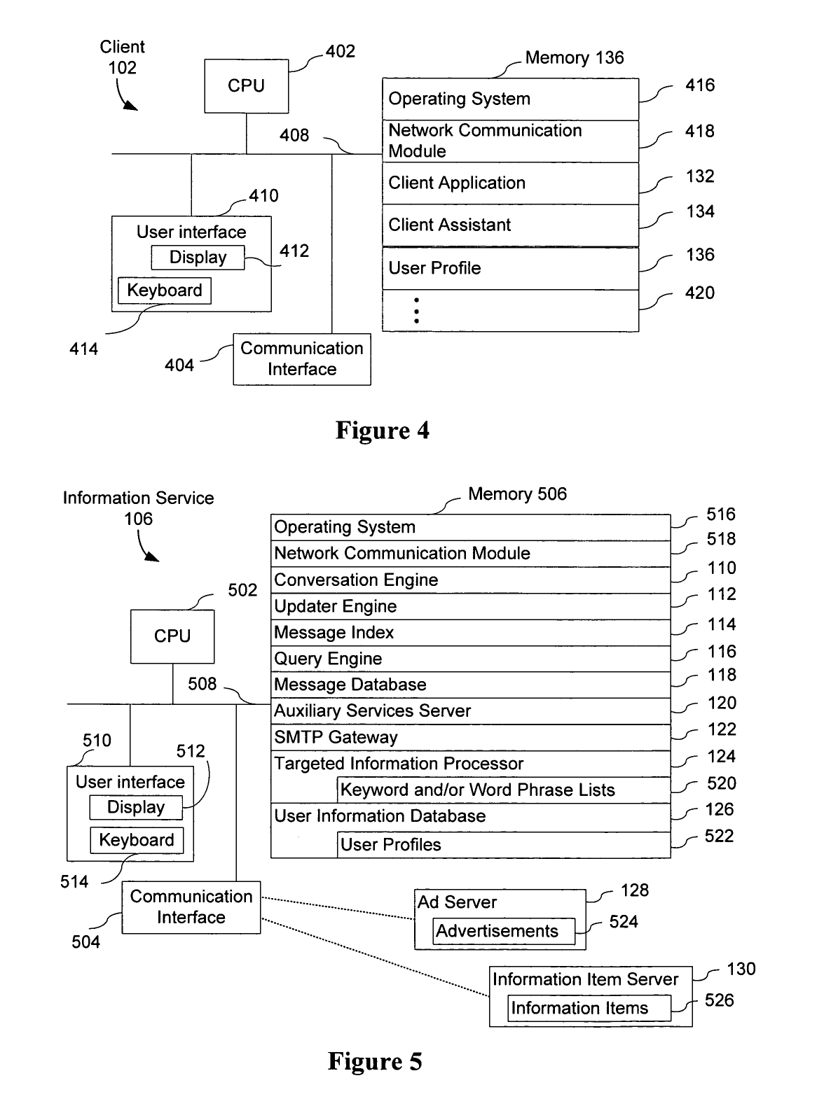

FIG. 5 is a block diagram illustrating an information service 106 in accordance with one embodiment of the present invention. The information service 106 typically includes one or more processing units (CPUs) 502, one or more network or other communications interfaces 504, memory 506, and one or more communication buses 508 for interconnecting these components. The information service 106 optionally may include a user interface 510 comprising a display device 512 and a keyboard 514. Memory 506 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 506 may optionally include one or more storage devices remotely located from the CPU(s) 502. In some embodiments, memory 506 stores the following programs, modules and data structures, or a subset thereof:
an operating system 516 that includes procedures for handling various basic system services and for performing hardware dependent tasks;
a network communication module 518 that is used for connecting (wired or wireless) the information service 106 to other computers via the one or more communication network interfaces 504 and one or more communication networks, such as the Internet, other wide area networks, local area networks, metropolitan area networks, and so on;
a targeted information processor 124 for obtaining targeted information for a conversation as described above, including one or more keyword and/or word phrase lists 520, also as described above; and
user information database 126 that can include one or more user profiles as described above.

In some embodiments, the information service 106 includes the following elements, or a subset or superset of such elements: a conversation engine 110 for responding to a variety of requests from the client assistant 134 returning conversation-based responses; an updater engine 112 for updating a message database 118; a message index 114 containing index information for messages in the message database 118; a query engine 116 for performing various queries using the message index 114 and message database 118; an auxiliary services server 120 for performing various auxiliary services; and an SMTP gateway 122 for sending and receiving messages.

The information service 106 can be connected to an ad server 128 and/or an information item server 130 via the communication interface 504. The ad server 128 can contain one or more advertisements 524. The ad server 128 can receive input and return advertisements that can be relevant to the input. The information item server 130 can include one or more information items 526. Similar to the ad server 128, the information server 130 can receive input and return informational items that can be relevant to the input.

Each of the above identified elements in FIGS. 4 and 5 can be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, the memory 506 may store a subset of the modules and data structures identified above. Furthermore, the memory 506 may store additional modules and data structures not described above.

Although FIGS. 4 and 5 show, respectively a client 102 and an information service 106, the figures are intended more as functional description of the various features which may be present in a client and set of servers than as a structural schematic of the embodiments described herein. In practice, and as recognized by those of ordinary skill in the art, items shown separately could be combined and some items could be separated. For example, some items shown separately in FIG. 5 could be implemented on single servers and single items could be implemented by one or more servers. The actual number of servers used to implement an information service 106 and how features are allocated among them will vary from one implementation to another, and may depend in part on the amount of data traffic that the system must handle during peak usage periods as well as during average usage periods.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1-41. (canceled)

42. A method of presenting information, comprising:
at a client device with one or more processors, memory, and a display:
detecting a user input requesting a list of conversations;
in response to detecting the user input, sending, to a server system, a request for the list of conversations; and
after sending the request:
receiving, from the server system, the list of conversations and one or more additional information items;
displaying the list of conversations in a first region of the display, wherein a plurality of conversations in the list of conversations each includes a plurality of distinct messages; and
while displaying the list of conversation in the first region of the display, concurrently displaying the one or more additional information items in a second region of the display, wherein at least one of the one or more additional information items is relevant to at least one content component from one or more messages in the list of conversations.

43. The method of clam 42, wherein a respective additional information item of the one or more additional information items in the second region of the display has one or more dimensions substantially similar to one or more corresponding dimensions of a respective item in the list of conversations.

44. The method of clam 42, wherein the second region of the display is distinct and separate from the first region of the display.

45. The method of clam 44, wherein the second region of the display is located substantially above the first region of the display.

46. The method of clam 44, wherein the second region of the display is horizontally adjacent to the first region of the display.

47. The method of clam 42, further comprising:
displaying, in the second region of the display, one or more navigation affordances associated with the one or more additional information items.

48. The method of clam 47, further comprising:
detecting a user input selecting one of the one or more navigation affordances; and
in response to detecting the user input, replacing display of at least one information item of the one or more additional information items displayed in the second region of the display with display of a different information item, distinct from the one or more additional information items displayed in the second region prior to the detection of the user input selecting one of the one or more navigation affordances.

49. The method of clam 42, wherein the one or more additional information items includes one or more of the group consisting of an advertisement, document link to a document or file stored locally or remotely from the client system, news item, map link, product review, phone number, web page link, dictionary entry, image, RSS feed, blog (web log) event, and user poll.

50. A client device, comprising:
a display;
memory;
one or more processors; and
at least one program, stored in the memory and executed by the one or more processors, the at least one program including:
instructions for detecting a user input requesting a list of conversations;
instructions, responsive to detecting the user input, for sending, to a server system, a request for the list of conversations;
instructions for receiving, from the server system, the list of conversations and one or more additional information items;
instructions for displaying the list of conversations in a first region of the display, wherein a plurality of conversations in the list of conversations each includes a plurality of distinct messages; and
instructions, operative while displaying the list of conversation in the first region of the display, for concurrently displaying the one or more additional information items in a second region of the display, wherein at least one of the one or more additional information items is relevant to at least one content component from one or more messages in the list of conversations.

51. The system of claim 50, wherein a respective additional information item of the one or more additional information items in the second region of the display has one or more dimensions substantially similar to one or more corresponding dimensions of a respective item in the list of conversations.

52. The system of claim 50, wherein the second region of the display is distinct and separate from the first region of the display.

53. The system of claim 52, wherein the second region of the display is located substantially above the first region of the display.

54. The system of claim 52, wherein the second region of the display is horizontally adjacent to the first region of the display.

55. The system of claim 50, wherein the at least one program includes:
instructions for displaying, in the second region of the display, one or more navigation affordances associated with the one or more additional information items.

56. The system of claim 55, wherein the at least one program includes:
instructions for detecting a user input selecting one of the one or more navigation affordances; and
instructions, responsive to detecting the user input, for replacing display of at least one information item of the one or more additional information items displayed in the second region of the display with display of a different information item, distinct from the one or more additional information items displayed in the second region prior to the detection of the user input selecting one of the one or more navigation affordances.

57. The system of claim 50, wherein the one or more additional information items includes one or more of the group consisting of an advertisement, document link to a document or file stored locally or remotely from the client system, news item, map link, product review, phone number, web page link, dictionary entry, image, RSS feed, blog (web log) event, and user poll.

58. A non-transitory computer readable storage medium storing one or more programs for execution by one or more processors of a client device, the one or more programs comprising:
instructions for detecting a user input requesting a list of conversations;
instructions, responsive to detecting the user input, for sending, to a server system, a request for the list of conversations;
instructions for receiving, from the server system, the list of conversations and one or more additional information items;
instructions for displaying the list of conversations in a first region of the display, wherein a plurality of conversations in the list of conversations each includes a plurality of distinct messages; and
instructions, operative while displaying the list of conversation in the first region of the display, for concurrently displaying the one or more additional information items in a second region of the display, wherein at least one of the one or more additional information items is relevant to at least one content component from one or more messages in the list of conversations.

59. The non-transitory computer readable storage medium of claim 58, wherein a respective additional information item of the one or more additional information items in the second region of the display has one or more dimensions substantially similar to one or more corresponding dimensions of a respective item in the list of conversations.

60. The non-transitory computer readable storage medium of claim 58, wherein the second region of the display is distinct and separate from the first region of the display.

61. The non-transitory computer readable storage medium of claim 60, wherein the second region of the display is located substantially above the first region of the display.

62. The non-transitory computer readable storage medium of claim 60, wherein the second region of the display is horizontally adjacent to the first region of the display.

63. The non-transitory computer readable storage medium of claim 58, wherein the one or more programs comprise:
instructions for displaying, in the second region of the display, one or more navigation affordances associated with the one or more additional information items.

64. The non-transitory computer readable storage medium of claim 63, wherein the one or more programs comprise:
instructions for detecting a user input selecting one of the one or more navigation affordances; and
instructions, responsive to detecting the user input, for replacing display of at least one information item of the one or more additional information items displayed in the second region of the display with display of a different information item, distinct from the one or more additional information items displayed in the second region prior to the detection of the user input selecting one of the one or more navigation affordances.

65. The non-transitory computer readable storage medium of claim 58, wherein the one or more additional information items includes one or more of the group consisting of an advertisement, document link to a document or file stored locally or remotely from the client system, news item, map link, product review, phone number, web page link, dictionary entry, image, RSS feed, blog (web log) event, and user poll.
